(19) United States
(12) Patent Application Publication
(10) Pub. No.: US 2018/0194609 A1
(43) Pub. Date: Jul. 12, 2018

(54) BEVERAGE SERVING APPARATUS

(71) Applicant: Pub Pour, Inc., Lake Forest Park, WA (US)

(72) Inventors: Clark Manning Henderson, Lake Forest Park, WA (US); Thomas John Laha, Lake Forest Park, WA (US)

(21) Appl. No.: 15/863,813

(22) Filed: Jan. 5, 2018

Related U.S. Application Data
(60) Provisional application No. 62/445,584, filed on Jan. 12, 2017.

(51) Int. Cl. B67D 3/00; B67C 11/02

(52) U.S. Cl. CPC B67D 3/0058; B67C 11/02

(57) ABSTRACT

A beverage serving apparatus is configured to produce an optimal amount of head (or layer of foam) and foam stability when a beverage is poured through the beverage serving apparatus and into a vessel. The beverage serving apparatus includes an inlet, an outlet, and a conduit having a variable cross-sectional dimension extending between the inlet and the outlet.

### CROSS REFERENCE TO RELATED APPLICATION

This application claims priority to commonly assigned, co-pending U.S. Provisional Patent Application Ser. No. 62/445,584, filed Jan. 12, 2017. Application Ser. No. 62/445,584 is fully incorporated herein by reference.

### BACKGROUND

Certain beverages contain dissolved gas. Take beer, for example. Most beer is carbonated, meaning it contains dissolved carbon dioxide (CO₂). Carbonation in beer goes back hundreds of years, and is the result of the brewing process itself; fermentation produces CO₂ and alcohol as a by-product. Beer aficionados, and consumers alike, have grown accustom to carbonation in beer. Carbonation gives beer a familiar appearance, aroma, flavor, and mouthfeel. As such, today's breweries carefully dissolve a particular amount of CO₂ in solution (the beer) and package the beer under pressure within sealed containers, such as in kegs, bottles, cans, or the like.

A more recent advent has come by way of nitrogenated beverages. Guinness®, of Dublin, Ireland, pioneered nitrogenated beer around the 1940's. Today's nitrogenated beer often contains 70% dissolved nitrogen gas (N₂), and 30% dissolved CO₂. Furthermore, beer is not the only type of beverage to embrace this trend for nitrogenation. For instance, nitrogenated coffee has also become quite popular in recent years.

Regardless of the type of beverage, or the type of gas dissolved in the beverage, when a consumer opens a pressurized beverage container (e.g., a keg, bottle, can, or the like) and pours the beverage into a glass, the release of pressure from opening the container causes the dissolved gas to precipitate, or “come out” of solution. At this stage, a consumer will typically witness the formation of bubbles throughout the liquid, as well as a layer of foam (often called “head”) at the surface of the liquid. Head (the layer of foam at the top surface of the beverage) is one of many factors that is evaluated in assessing the quality of a pour of beer. In fact, when beer is poured out of a tap, a particular amount of head is often desirable, as head production in beer is an important component in the release of volatile aromatics that enhance beer flavor. This is especially true with nitrogenated beers. For example, an optimally thick head on the top surface of a nitrogenated beer is known to produce a creamy, rich mouthfeel for the consumer of the beer, and this head is therefore desirable in a bar or restaurant setting where beer is poured from a tap.

To achieve the optimal amount of head in a glass of Nitrogenated beer, Stout taps contain a restrictor plate that includes a metallic disk with several small holes. Beer is forced through the small holes in the restrictor plate using back pressure, and this process agitates the beer as it is poured into the glass. This, in turn, causes a layer of foam (head) to form at the top of the glass, as well as a cascading “reverse waterfall” effect on the sides of the glass where the bubbles move downward along the sides and toward the bottom of the glass. In regards to carbonated beer, the factors that contribute to achieving an optimal amount of head is in part due to the higher partial pressure of CO₂ at which beer is maintained in the keg, which allows for a higher amount of dissolved CO2 in the beer, and in part due to the pouring technique used by the bartender.

In addition to kegs and taps that are found in bars, restaurants, and breweries, beer manufacturers also sell beer in bottles and cans to consumers. It is difficult, however, to replicate the tap-dispensed beer experience when beer is poured from a bottle or a can. It is especially challenging to replicate a tap-dispensed nitrogenated beverage from a bottle or can. To address this challenge, some manufacturers have placed “widgets” (e.g., a plastic ball with one or more small pin holes) inside the pressurized bottle or can at the time of manufacture. The widget is designed in an attempt to replicate the tap-dispensed experience by filling the widget with beer under pressure, and when the bottle or a can is opened, the pressure differential causes the beer inside the widget to expel from the small pin hole in a jet stream, which causes turbulence in the beer and helps to create a head on the beer when it is poured from the bottle or can into a glass. The widget is an added cost of manufacturing (both in terms of added material and added processing steps, such as dosing of liquid nitrogen) that is passed onto the consumer, and may not accurately replicate the tap-dispensed experience that has the benefit of utilizing back pressure and a restrictor plate to achieve an optimal head in the glass. In addition, the widget makes the recycling process more difficult, as the widget may need to be removed from the can or bottle before the can or bottle can be recycled.

Other beer manufacturers may vary the levels of dissolved nitrogen and/or head pressure, or may simply instruct their customers to pour the beer into the glass using a specific technique (e.g., using a “hard pour” where the consumer abruptly inverts an open bottle and pours the beer into the bottom of the glass) to create a better head in the glass. However, hard pouring beer can produce a less stable head that does not last as long as that produced by a stout faucet, and hard pouring can also increase the dissolved oxygen in the beer, thereby reducing the production of favorable volatile compounds that enhance the beer drinking experience. Furthermore, there is an increased risk of spillage during a hard pour, and simply providing pouring instructions to a user is known to be wrought with user error, thereby producing pours of inconsistent quality, at least in terms of the amount of head produced in the glass. Thus, consumers may not enjoy a nitrogenated (or carbonated) beer to its full extent when consuming the beer out of a bottle or a can.

### SUMMARY

The current disclosure provides an apparatus that addresses and solves many drawbacks of the prior art. Particularly disclosed herein is a beverage serving apparatus that is configured to produce an optimal amount of head (or layer of foam) when the beverage serving apparatus is used by pouring a beverage through the beverage serving apparatus and into a vessel, such as a glass. The beverage serving apparatus includes an inlet disposed at a proximal end of the beverage serving apparatus, an outlet disposed at a distal end of the beverage serving apparatus, and a conduit extending between the inlet and the outlet, the conduit having a variable cross-sectional dimension along a path from the inlet to the outlet.

In some embodiments, the variable cross-sectional dimension of the conduit is achieved by the beverage serving apparatus including one or more chambers, wherein an individual chamber of the one or more chambers varies (e.g., increases and/or decreases) in cross-sectional dimension along the path from the inlet to the outlet. For example, the conduit of the beverage serving apparatus can be defined by a chamber including a proximal portion where the cross-sectional dimension of the conduit progressively increases in a direction from the inlet to the outlet, a middle portion where the cross-sectional dimension of the conduit remains constant, and a distal portion where the cross-sectional dimension of the conduit progressively decreases in the direction from the inlet to the outlet.

In some embodiments, the variable cross-sectional dimension of the conduit is achieved by the beverage serving apparatus including multiple chambers and a connecting tube. In these embodiments, the multiple chambers include a proximal chamber near a proximal end of the beverage serving apparatus and a distal chamber near a distal end of the beverage serving apparatus. The connecting tube can be disposed between the proximal chamber and the distal chamber and may couple the proximal chamber to the distal chamber. The conduit within the proximal chamber may have a first cross-sectional dimension, the conduit within the distal chamber may have a second cross-sectional dimension, and the conduit within the connecting tube may have a third cross-sectional dimension that is less than each of the first cross-sectional dimension and the second cross-sectional dimension. In other words, the cross-sectional dimension of the conduit reduces in size in the transition from the proximal chamber to the connecting tube, and increases in size in the transition from the connecting tube to the distal chamber.

The beverage serving apparatus disclosed herein may be used to pour a beverage from an opened container into the beverage serving apparatus, where after the liquid beverage flows through the conduit of the beverage serving apparatus and exits the beverage serving apparatus into a vessel, such as a glass. As the liquid beverage flows through the conduit of the beverage serving apparatus, the variable cross-sectional dimension of the conduit causes the flowrate of the liquid to vary, thereby causing fluctuations in pressure, as the liquid beverage flows through the beverage serving apparatus. The fluctuation in pressure, in turn, causes the dissolved gas in the beverage to come out of solution (or precipitate) at a desirable rate, producing an optimal amount of head in the glass.

Different relative dimensions (e.g., different ratios of minimum-to-maximum cross-sectional dimensions along the length of the conduit, different overall lengths of the beverage serving apparatus, etc.) may be selected for different types of beverages and/or for beverages having different types of dissolved gases. For example, the overall length of the beverage serving apparatus may be different for nitrogenated beers than the length of the beverage serving apparatus that is selected for beers that are solely carbonated with CO₂. As another example, the ratio of the minimum cross-sectional dimension of the conduit to the maximum cross-sectional dimension of the conduit may be different for a nitrogenated coffee than the ratio that is selected for a nitrogenated beer. With the correct dimensions and number of chambers, the beverage serving apparatus can produce optimal head for any type of beverage containing any type of dissolved gas. Furthermore, the cost of manufacturing (e.g., bottling or canning) the beverage can be minimized while a consumer pays a one-time fee for the beverage serving apparatus. For instance, the disclosed beverage serving apparatus allows any brewer to produce nitrogenated or other types of beer without the need to develop their own technology or pay for expensive, specially designed cans to properly dispense their product. This is particularly important for small breweries that cannot invest in the research and development of a new technology to compete with larger entities. The beverage serving apparatus disclosed herein also provides an improved user experience in terms of the enjoyment the user gets out of consuming a nitrogenated or carbonated beverage in situations where the beverage is enjoyed from a bottle or a can.

Other features and advantages of the present invention will become apparent from the following description of the invention, which refers to the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a perspective view of an example beverage serving apparatus according to embodiments disclosed herein.

FIG. 2 illustrates a side view of the example beverage serving apparatus of FIG. 1, FIG. 2 showing internal features of the beverage serving apparatus in dashed lines.

FIG. 3 illustrates a top view of the example beverage serving apparatus of FIG. 1.

FIG. 4 illustrates a bottom view of the example beverage serving apparatus of FIG. 1.

FIG. 5 illustrates a cross-sectional view of the example beverage serving apparatus of FIG. 2, taken along section line A-A.

FIG. 6 illustrates a cross-sectional view of the example beverage serving apparatus of FIG. 2, taken along section line B-B.

FIG. 7 illustrates a cross-sectional view of the example beverage serving apparatus of FIG. 3, taken along section line C-C.

FIG. 8 illustrates a partial side view of an example beverage serving apparatus at a distal end of the beverage serving apparatus, FIG. 8 showing an example outlet included in a distal chamber without an outlet structure.

FIG. 9 illustrates a partial side view of another example beverage serving apparatus at a distal end of the beverage serving apparatus, FIG. 9 showing an example outlet structure of the beverage serving apparatus that includes the outlet.

FIG. 10A illustrates a partial side view of another example beverage serving apparatus at a distal end of the beverage serving apparatus, FIG. 10A showing an example outlet structure having a mating feature that allows the beverage serving apparatus to matingly engage with a vessel.

FIG. 10B illustrates a bottom view of the example beverage serving apparatus shown in FIG. 10A.

FIG. 11A illustrates a partial side view of another example beverage serving apparatus at a distal end of the beverage serving apparatus, FIG. 11A showing another example outlet structure having a mating feature that allows the beverage serving apparatus to matingly engage with a vessel.

FIG. 11B illustrates a bottom view of the example beverage serving apparatus shown in FIG. 11A.

FIG. 12 illustrates a side view of an example beverage serving apparatus during use of the beverage serving apparatus to facilitate pouring a liquid beverage from an opened container, through the beverage serving apparatus, and into a vessel.

FIG. 13 illustrates side views of various example beverage serving apparatus according to embodiments disclosed herein.

FIG. 14 illustrates a partial side view of an example beverage serving apparatus at a proximal end of the beverage serving apparatus, FIG. 14 showing an example inlet structure according to embodiments disclosed herein.

FIG. 15 illustrates a side view of an example beverage serving apparatus that includes an angled or curved outlet structure, FIG. 15 illustrating the beverage serving apparatus during use to facilitate pouring a liquid beverage from an opened container, through the beverage serving apparatus, and into a vessel.

FIG. 16 illustrates a side view of an example beverage serving apparatus that produces suitable head for nitrogenated beer according to embodiments disclosed herein.

FIG. 17 illustrates a side view of an example beverage serving apparatus that produces suitable head for carbonated beer according to embodiments disclosed herein.

### DETAILED DESCRIPTION

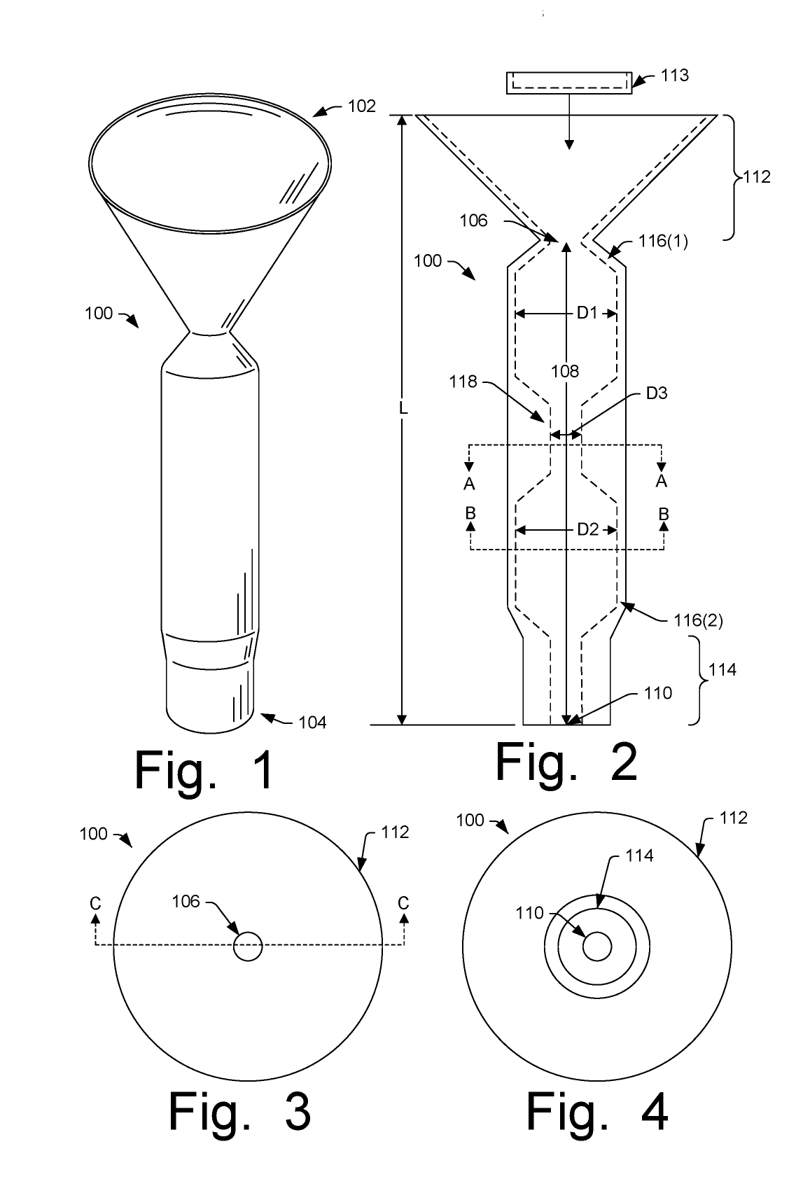

Referring to FIG. 1, there is illustrated a beverage serving apparatus 100 according to an example embodiment. The beverage serving apparatus 100 is shown from a perspective view in FIG. 1. FIG. 2 illustrates a side view of the example beverage serving apparatus 100 of FIG. 1. Meanwhile, FIGS. 3 and 4 illustrate top and bottom views, respectively, of the beverage serving apparatus 100 of FIG. 1.

The beverage serving apparatus 100 has a proximal end 102 and a distal end 104. As shown in FIG. 2, an inlet 106 of the beverage serving apparatus 100 is disposed at the proximal end 102 of the beverage serving apparatus 100. The inlet 106 is configured to receive a liquid beverage as the beverage is poured from an opened container into the beverage serving apparatus 100. The inlet 106 also represents the start of a conduit 108 that extends from the inlet 106 to an outlet 110, and is configured to convey fluid (e.g., a liquid beverage) through the beverage serving apparatus 100 as the fluid enters the conduit 108 through the inlet 106 and exits (or is released from) the conduit 108 through the outlet 110. The outlet 110 is disposed at the distal end 104 of the beverage serving apparatus 100.

In some embodiments, the beverage serving apparatus 100 includes an inlet structure 112 to facilitate the reception of a liquid beverage into the beverage serving apparatus 100 and to reduce spillage when pouring a beverage into the apparatus 100. FIGS. 1-4 show an example inlet structure 112 in the form of a funnel that is configured to funnel (or otherwise direct) fluid as the fluid is poured into the inlet structure 112 toward the inlet 106 under the force of gravity. A funnel is merely one example type of inlet structure 112 contemplated herein, as other inlet structures 112 may be used without changing the basic characteristics of the beverage serving apparatus 100. In some embodiments, the inlet structure 112 may be configured to receive a filter accessory 113 that can be placed in the inlet structure 112. Such a filter accessory 113 may be in the form of a basket insert, or a cylindrical dish insert, and may be configured to be filled with dried hops. The filter accessory 113 may be permeable to allow a beverage to pass through the filter accessory 113. Using the filter accessory 113, and while the filter accessory 113 is placed within the inlet structure 112, a user can pour a beverage (e.g., carbonated beer) over dried hops in the filter accessory 113, which can cause extraction of volatile aromatic compounds from the hops while the apparatus 100 is being used. The filter accessory 113 may be made of a disposable material to allow for discarding the filter accessory 113 after use. Alternatively, the filter accessory 113 may be reusable.

In some embodiments, the beverage serving apparatus 100 includes an outlet structure 114. FIGS. 1-4 shown an example outlet structure 114 in the form of a projection that extends from an end of a distal chamber of the beverage serving apparatus 100 at the distal end 104 thereof. The outlet structure 114 is configured to direct the fluid released from the outlet 110 into a vessel, such as a glass, cup, mug, or a similar type of vessel typically used for holding a beverage that is to be consumed by a person. FIGS. 1-4 show the outlet 110 as being disposed within the outlet structure 114. It is to be appreciated, however, that the outlet structure 114 can be omitted from the beverage serving apparatus 100 and the outlet 110 included in a distal chamber of the apparatus 100, as will be described in more detail below.

As shown by the internal features in dashed lines that are exhibited in FIG. 2, the conduit 108 is defined by a channel extending through the beverage serving apparatus 100 that has a variable cross-section dimension along a path from the inlet 106 to the outlet 110. For example, the beverage serving apparatus 100 shown in FIG. 2 includes a proximal chamber 116(1) near the proximal end 102, and the proximal chamber 116(1) is coupled to the inlet structure 112, the inlet 106 being formed at the junction of the proximal chamber 116(1) and the inlet structure 112. The proximal chamber 116(1) is shown as having a first inner cross-sectional dimension, D1. Said another way, the conduit 108 within the proximal chamber 116(1) has a first cross-sectional dimension, D1. The proximal chamber 116(1) is configured to enclose the liquid flowing through the apparatus 100. Although FIG. 2 shows the proximal chamber 116(1) as having a variable inner cross-sectional dimension itself, it is to be appreciated that the proximal chamber 116(1) can alternatively have a constant inner cross-sectional dimension, D1. For a cylindrically-shaped proximal chamber 116(1), the first cross-sectional dimension, D1, may include a first diameter, D1. It is to be appreciated, however, that the chambers 116 of the beverage serving apparatus 100 disclosed herein are not limited to cylindrically-shaped chambers 116, as the chambers 116 may include any polygonal cross-sectional shape, such as a triangular cross section, a square cross-section, a pentagonal cross-section, and so on.

The beverage serving apparatus 100 shown in FIG. 2 also includes a distal chamber 116(2) near the distal end 104 of the apparatus 100. The distal chamber 116(2) is configured to enclose the liquid flowing through the apparatus 100. The distal chamber 116(2) can be coupled to the outlet structure 114, and the distal chamber 116(2) has a second inner cross-sectional dimension, D2. Said another way, the conduit 108 within the distal chamber 116(2) has a second cross-sectional dimension, D2. This second cross-sectional dimension, D2, can include a second diameter, D2, when the distal chamber 116(2) is cylindrically-shaped. The second cross-sectional dimension, D2, may be the same size as the first cross-sectional dimension, D1. Alternatively, the respective cross-sectional dimensions D1 and D2 can be of different sizes. As used herein, the first inner cross-sectional dimension, D1, of the proximal chamber 116(1) can be “substantially equal” to the second inner cross-sectional dimension, D2, of the distal chamber 116(2) when D1 and D2 are within a tolerance of 0.5 mm.

The beverage serving apparatus 100 of FIG. 2 is also shown as including a connecting tube 118 (which may also be cylindrical in shape). The connecting tube 118 is disposed between the proximal chamber 116(1) and the distal chamber 116(2), and couples (or connects) the proximal chamber 116(1) to the distal chamber 116(2). The connecting tube 118 may have a third inner cross-sectional dimension, D3, (e.g., a third inner diameter, D3) that is less than each of the first inner cross-sectional dimension, D1, and the second inner cross-sectional dimension, D2, of the proximal and distal chambers 116(1) and 116(2), respectively. Said another way, the conduit 108 within the connecting tube 118 may have a third cross-sectional dimension, D3, such that the size of the conduit's 108 cross section reduces from D1 to D3 at the transition from the proximal chamber 116(1) to the connecting tube 118, and increases from D3 to D2 at the transition from the connecting tube 118 to the distal chamber 116(2).

FIG. 2 further shows the beverage serving apparatus 100 as having an overall length, L. In some embodiments, the overall length, L, of the beverage serving apparatus 100 is no greater than 610 millimeters (mm), no greater than 500 mm, no greater than 450 mm, no greater than 400 mm, no greater than 350 mm, no greater than 300 mm, no greater than 250 mm, no greater than 200 mm, no greater than 150 mm, no greater than 125 mm, no greater than 100 mm, no greater than 75 mm, no greater than 50 mm, or no greater than 25 mm. In some embodiments, the overall length, L, of the beverage serving apparatus 100 is at least 25 mm, at least 50 mm, at least 75 mm, at least 100 mm, at least 125 mm, at least 150 mm, at least 200 mm, at least 250 mm, at least 300 mm, at least 350 mm, at least 400 mm, at least 450 mm, at least 500 mm, or at least 610 mm. In some embodiments, the length, L, of the beverage serving apparatus 100 that produces suitable head for nitrogenated or carbonated beer is in a range of 165 to 195 mm.

In some embodiments, a ratio of the inner cross-sectional dimension, D3, of the connecting tube 118 to the inner cross-sectional dimension, D1, of the proximal chamber 116(1) includes a one-to-three (1:3) ratio. For example, the cross-sectional dimension, D3, may be a diameter of 5 mm, while the cross-sectional dimension, D1, may be a diameter of 15 mm. However, the ratio of D3:D1 is not limited to a 1:3 ratio, as other ratios are contemplated herein. For example, the ratio of D3:D1 can include a 1:1.5 ratio, or any other suitable ratio. A 1:3 ratio for D3:D1 may produce suitable or optimal head for nitrogenated or carbonated beer.

The ratio of the inner cross-sectional dimension, D3, of the connecting tube 118 to the inner cross-sectional dimension, D2, of the distal chamber 116(2) may include a ratio that is similar to, or the same as, the ratio of D3:D1. In other words, the ratio of D3:D2 may equal the ratio of D3:D1, when D1=D2.

Varying the cross-sectional dimension of the conduit 108 in the manner described herein produces an “agitation” effect on the fluid (e.g., liquid beverage) as it flows through the beverage serving apparatus 100. Thus, when the fluid is a liquid beverage that contains a dissolved gas, precipitation of the dissolved gas is promoted by the flow of the liquid beverage through the conduit 108 of the beverage serving apparatus 100. The dimensions of the beverage serving apparatus 100, such as the cross-sectional dimension (D1, D2, D3) of the various portions of the conduit 108 from the inlet 106 to the outlet 110, as well as the overall length, L, of the beverage serving apparatus 100 (and/or the length of the conduit 108 itself), may be selected according to the type of beverage and/or the type of dissolved gas in question. For example, one or more dimensions of the apparatus 100 may vary based on whether the apparatus 100 is to be used with nitrogenated beer or carbonated beer. It is to be appreciated that a “type of dissolved gas,” as used herein, may refer to a single gas type or a mixture of multiple types of gases. For example, a nitrogenated beer may have about 75% dissolved N₂, and about 25% dissolved CO₂, meaning that the “type of dissolved gas” in a nitrogenated beer may be a mixture of nitrogen and carbon dioxide gas (sometimes called “beer gas”). Meanwhile, some other types of beverages (e.g., nitrogenated coffee) may have 100% dissolved N₂, meaning that the “type of dissolved gas” may be pure nitrogen gas.

In addition, the length, L, of the beverage serving apparatus 100 (and/or the length of the conduit 108) may be modified by adding or removing chambers 116 to or from the beverage serving apparatus 100. For example, a third chamber could be added to the two-chamber version of the beverage serving apparatus 100 shown in FIGS. 1-4 in order to lengthen the beverage serving apparatus 100 and/or lengthen the conduit 108. Alternatively, one of the chambers 116(1) or 116(2) may be removed/omitted in order to shorten the beverage serving apparatus 100 and/or shorten the conduit 108. In addition, the length, L, of the beverage serving apparatus 100 (and/or the length of the conduit 108) can be modified (i.e., shortened or lengthened) without adding or removing chambers 116 to or from the apparatus 100, and instead, the length, L, can be changed by reducing or increasing the length of one or more of the chambers 116, one or more of the connecting tubes 118, the outlet structure 114, and/or the inlet structure 112 of the apparatus 100. Accordingly, the beverage serving apparatus 100 can be designed for any given beverage to produce the optimal amount of head when the beverage is received in a vessel through the beverage serving apparatus 100.

The beverage serving apparatus 100 may be made of any suitable material, combination of materials, or composite materials. For example, the beverage serving apparatus 100 can be made of metal, such as copper, aluminum, stainless steel, or any other suitable metallic material, or metallic coating on another type of base material. In other embodiments, the beverage serving apparatus 100 can be made of glass, ceramic, wood, or any other suitable material commonly used in kitchen appliances or tools. In some embodiments, the beverage serving apparatus 100 can be made of a molded plastic or polymer. Silicone may be a suitable food-grade material for use in making the beverage serving apparatus 100. In general, any suitably rigid or semi-rigid material that is waterproof, and/or resistant to chemicals, heat and stress are preferred to make the beverage serving apparatus 100.

In some embodiments, the beverage serving apparatus 100 may be manufactured using an injection molding technique, or an extrusion technique, the processes for which should be apparent to a person having ordinary skill in the art. By using an injection molding method to manufacture the beverage serving apparatus 100, minimal material is used for the manufacture of the apparatus 100, thereby preventing excess waste of material. Furthermore, injection molding techniques allow for easily forming the conduit 108 within the beverage serving apparatus 100. Other manufacturing techniques that may be used to manufacture the apparatus 100 include machining a material into the shape of the apparatus 100, or into component parts of the apparatus 100 that are subsequently attached together during manufacture using any suitable fastening means, such as screws, pins, joints, adhesives, or the like. Any other subtractive manufacturing techniques can be used besides machining. Additionally, additive manufacturing techniques, such as 3D printing, can be used to manufacture the apparatus 100.

It is to be appreciated that the specific dimensions, proportions, shapes and configurations of any portion of the beverage serving apparatus 100 are not specific to the present invention. For example, the beverage serving apparatus 100 may have any suitable cross-sectional geometry in addition to a cylindrical geometry described in the examples herein. Additionally, the apparatus 100 may be shaped in any suitable shape along the length, L, such as a helical shape where the apparatus 100 takes on a spiral form instead of a straight configuration as shown in FIGS. 1-4, or any portion of the apparatus 100 can be angled or curved. The outer surface of the beverage serving apparatus 100 may be shaped or contoured in various ways to provide various ergonomics or aesthetics for a user, and the thickness of the walls between the outer surface and the conduit 108 can be of any suitable thickness to provide suitable rigidity to the apparatus 100 preferably without adding too much weight or bulk thereto.

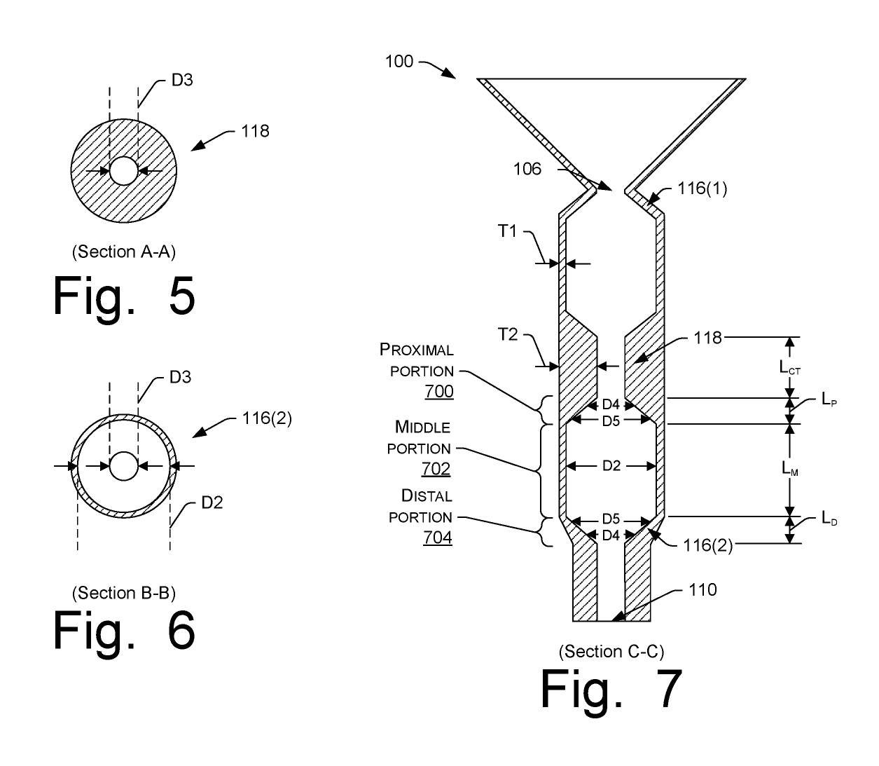

FIG. 5, illustrates a cross-sectional view of the example beverage serving apparatus 100 of FIG. 2, taken along section line A-A. FIG. 5 shows the inner cross-sectional dimension, D3, of the connecting tube 118 as a diameter, D3, of a circular shaped cross-section of a cylindrical connecting tube 118. However, as noted above, the cross-sectional shape of the connecting tube 118 is not limited to a circular cross-sectional shape, and the cross-sectional dimension, D3, is therefore not limited to a diameter.

FIG. 6 illustrates a cross-sectional view of the example beverage serving apparatus 100 of FIG. 2, taken along section line B-B. FIG. 6 illustrates the cross-sectional dimensions D2 and D3 relative to each other from top view of the cross section. This view of FIG. 6 shows how the inner cross-sectional dimension, D3, of the connecting tube 118 is less than the inner cross-sectional dimension, D2, of the distal chamber 116(2). Furthermore, the connecting tube 118 is shown as being concentric with the distal chamber 116(2). Likewise, the connecting tube 118 may be concentric with the proximal chamber 116(1). However, it is to be appreciated that the connecting tube 118 does not have to be concentric with any adjacent chamber 116, and may instead be eccentric therewith (or offset from a center of the circular cross-section of the adjacent chamber 116).

FIG. 7 illustrates a cross-sectional view of the example beverage serving apparatus 100 of FIG. 3, taken along section line C-C. FIG. 7 shows how the wall thickness of the beverage serving apparatus 100 can vary along the length, L, of the apparatus 100. For example, a wall of the proximal chamber 116(1) can have a first thickness, T1, that is less than a second thickness, T2, of a wall of the connecting tube 118. This gives the outer surface of the apparatus 100 a uniform and smooth look and feel. Alternatively, the outer surface of the apparatus 100 may contour inward at the transition from the proximal chamber 116(1) to the connecting tube 118, such as by keeping a uniform thickness of the wall at the respective portions of the apparatus 100. This contoured outer surface may provide ergonomic benefits, or may offer a different aesthetic to the apparatus 100.

FIG. 7 also shows how an individual chamber 116 may have a variable inner cross-sectional dimension along the length of the chamber 116. This is shown in FIG. 7 at the distal chamber 116(2) by the distal chamber 116(2) including a proximal portion 700 having a progressively increasing inner cross-sectional dimension in a direction from the inlet 106 to the outlet 110, a middle portion 702 having a constant inner cross-sectional dimension, D2, and a distal portion 704 having a progressively decreasing inner cross-sectional dimension in the direction from the inlet 106 to the outlet 110. For instance, the proximal portion 700 of the distal chamber 116(2) can have an inner cross-sectional dimension (e.g., inner diameter) that progressively increases from D3 to D4 to D5, where D3 is less than D4, and D4 is less than D5, and ultimately to D2, where the proximal portion 700 transitions to the middle portion 702. Here, D2 is greater than D3, D4, and D5. Likewise, the distal portion 704 of the distal chamber 116(2) can have an inner cross-sectional dimension (e.g., inner diameter) that progressively decreases from D2 to D5 to D4, where D2 is greater than D5, and D5 is greater than D4, and ultimately to D3, where the distal portion 704 transitions to the outlet structure 114. Alternatively, the transition from the inner cross-sectional dimension, D3, of the connecting tube 118 to the inner cross-sectional dimension, D2, of the distal chamber 116(2) can be an abrupt change rather than a progressively increasing change. For example, the transition from the cross-sectional dimension of the conduit 108 can transition in a stepwise manner from a smaller inner cross-sectional dimension, D3, to a larger inner cross-sectional dimension, D2, at the junction between the connecting tube 118 and the distal chamber 116(2). The same abrupt change in the cross-sectional dimension of the conduit 108 can be implemented in the transition from a chamber 116 to a connecting tube 118.

FIG. 7 further shows a length, L_{P}, of the proximal portion 700 of the distal chamber 116(2), a length, L_{M}, of the middle portion 702 of the distal chamber 116(2), and a length, L_{D}, of the distal portion 704 of the distal chamber 116(2). Any of the chambers described herein can have these length dimensions, where a total length of a chamber 116 is equal to L_{P}+L_{M}+L_{D}. In some embodiments, the length, L_{P}, of the proximal portion 700 of the chamber 116 is equal to the length, L_{D}, of the distal portion 704 of the chamber 116. In some embodiments, the length, L_{P}, of the proximal portion 700 or the length, L_{D}, of the distal portion 704 of the chamber 116 is no greater than 10 mm, no greater than 8 mm, no greater than 6 mm, no greater than 4 mm, or no greater than 2 mm. In some embodiments, the length, L_{P}, of the proximal portion 700 or the length, L_{D}, of the distal portion 704 of the chamber 116 is at least 1 mm, at least 2 mm, at least 4 mm, at least 6 mm, at least 8 mm, or at least 10 mm. In some embodiments, the length, L_{P}, of the proximal portion 700 or the length, L_{D}, of the distal portion 704 of the chamber 116 that produces suitable head for nitrogenated or carbonated beer is in a range of 2 to 6 mm.

In some embodiments, the length, L_{M}, of the middle portion 702 of the chamber 116 is no greater than 20 mm, no greater than 15 mm, no greater than 10 mm, no greater than 5 mm, or no greater than 2 mm. In some embodiments, the length, L_{M}, of the middle portion 702 of the chamber 116 is at least 2 mm, at least 5 mm, at least 10 mm, at least 15 mm, or at least 20 mm. In some embodiments, the length, L_{M}, of the middle portion 702 of the chamber 116 that produces suitable head for nitrogenated beer is in a range of 8 to 12 mm. In some embodiments, the length, L_{M}, of the middle portion 702 of the chamber 116 that produces suitable head for carbonated beer is in a range of 3 to 7 mm. In some embodiments, a number of chambers 116 that produces suitable head for nitrogenated beer is three chambers 116, wherein a length, L_{CT}, of a first connecting tube 118 between the first and second chambers 116 is in a range of 3 to 7 mm, and a length, L_{CT}, of a second connecting tube 118 between the second and third chambers 116 is in a range of 3 to 7 mm. In some embodiments, a number of chambers 116 that produces suitable head for carbonated beer is one chamber.

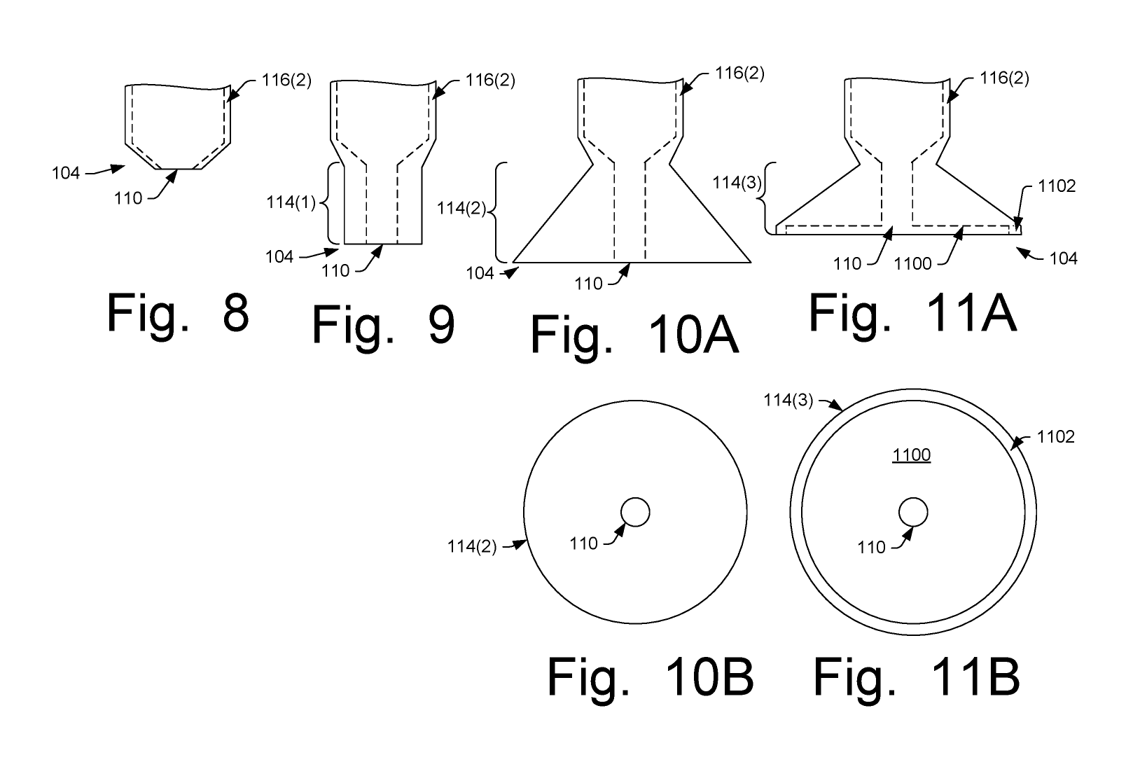

FIG. 8 illustrates a partial side view of an example beverage serving apparatus 100 at a distal end 104 of the beverage serving apparatus 100. FIG. 8 shows an example outlet 110 included in a distal chamber 116(2) without an outlet structure. Thus, liquid that is poured through the beverage serving apparatus 100 can exit (or be released from) the apparatus 100 at the outlet 110 of the distal chamber 116(2) without being conveyed through an outlet structure 114.

FIG. 9 illustrates a partial side view of another example beverage serving apparatus 100 at a distal end 104 of the beverage serving apparatus 100. FIG. 9 shows an example outlet structure 114(1) that can be included at the distal end 104 of the beverage serving apparatus 100 to direct liquid into a vessel as it is released from the outlet 110.

FIG. 10A illustrates a partial side view of another example beverage serving apparatus 100 at a distal end 104 of the beverage serving apparatus 100. FIG. 10A shows an example outlet structure 114(2) having a mating feature that allows the beverage serving apparatus 100 to matingly engage with a vessel. FIG. 10B illustrates a bottom view of the example beverage serving apparatus 100 shown in FIG. 10A. In FIGS. 10A and 10B, the mating feature of the outlet structure 114(2) includes an inverted cone with the conduit 108 passing through the inverted cone to the outlet 110. The mating feature of the outlet structure 114(2) in the form of an inverted cone shown in FIGS. 10A and 10B is configured to be inserted into the vessel up to a point where the inverted cone interferes with an angled vertical wall of the vessel at an inner surface of the angled vertical wall of the vessel. For example, most beer glasses are tapered inward at the side wall of the glass from the top to the bottom. In other words, the diameter of the mouth of the glass is larger than the diameter of the bottom. As such, the diameter of the inverted cone of the outlet structure 114(2) can be dimensioned to be larger than the diameter of the bottom of a typical pint glass, while being smaller than the diameter of the top (or mouth) of a typical pint glass. This allows a user to rest the apparatus 100 within the vessel as the liquid is being poured into the apparatus 100. This may allow for the user to avoid having to “hold up” the apparatus 100 when using the apparatus 100, and may instead focus more on pouring liquid into the apparatus 100 to avoid spillage.

FIG. 11A illustrates a partial side view of another example beverage serving apparatus 100 at a distal end 104 of the beverage serving apparatus 100. FIG. 11A shows another example outlet structure 114(3) having a mating feature that allows the beverage serving apparatus to matingly engage with a vessel. FIG. 11B illustrates a bottom view of the example beverage serving apparatus 100 shown in FIG. 11A. Here, the mating feature includes an inverted cone that includes a resting surface 1100 that is configured to be placed on a top edge of a vessel, and an annular retainer 1102 that is configured to extend around part of an outer surface of the vessel proximate to the top edge of the vessel. Said another way, the mating feature of the outlet structure 114(3) allows the apparatus 100 to be placed on the top of a vessel, such as a glass having a diameter that is less than the inner diameter of the annular retainer 1102, and the annular retainer 1102 thereby extends over and around the outer surface of the glass at the top of the glass, thereby retaining the apparatus 100 on the top of the glass by preventing side to side movement that is transverse to the vertical orientation of the glass.

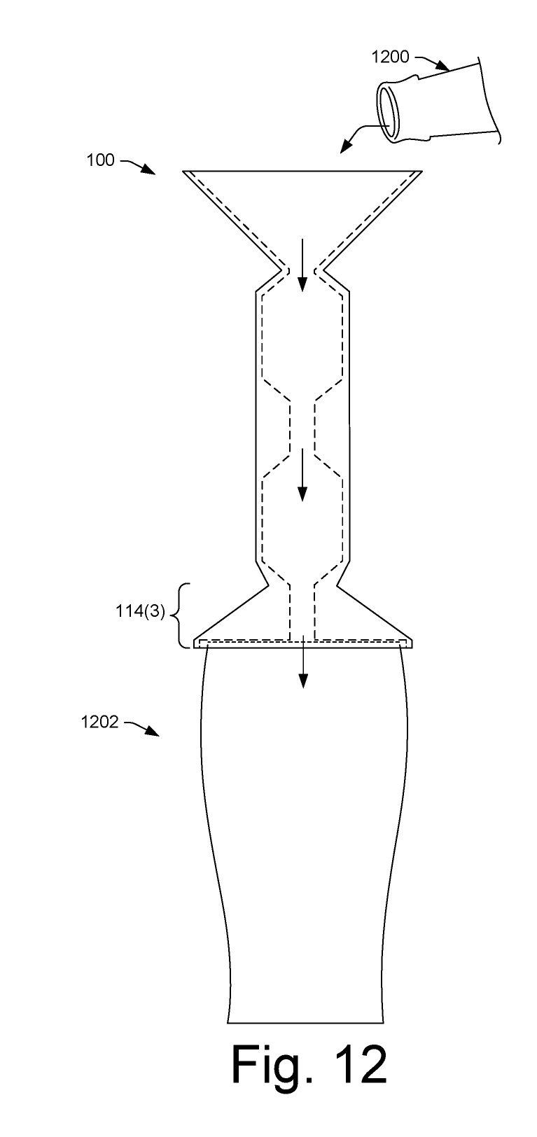

FIG. 12 illustrates a side view of an example beverage serving apparatus 100 that includes the outlet structure 114(3) having the mating feature including an inverted cone having the resting surface 1100 and the annular retainer 1102. FIG. 12 shows how the apparatus 100 can be used to facilitate pouring a liquid beverage from an opened container 1200, through the beverage serving apparatus 100, and into a vessel 1202. Here, the opened container 1200 is shown by way of example as a bottle, but the apparatus 100 can be used with any type of container 1200 typically used to contain a liquid beverage under pressure, such as a can, a growler, a miniature keg, or any other suitable container 1200.

As shown in FIG. 12, the outlet structure 114(3) that includes the mating feature of an inverted cone having a resting surface 1100 and an annular retainer 1102 (See FIGS. 11A and 11B) allow for a user to conveniently rest the beverage serving apparatus 100 atop the vessel 1202, which is represented in FIG. 12 as a pint glass, typically used to drink beer from. The arrows running from the container 1200 through the apparatus 100 and into the vessel 1202 represent a general path taken by the liquid that is poured from the container 1200 and into the apparatus 100 at the inlet structure 112. As the liquid passes through the apparatus 100, the variable cross-sectional dimension of the conduit 108 extending from the inlet 106 to the outlet 110 promotes precipitation of dissolved gas in the liquid, thereby producing a head in the vessel 1202 when the vessel 1202 is filled with the liquid, the head being formed at the top of the vessel 1202. For instance, the container 1200 may represent a recently opened bottle of nitrogenated beer. As the beer flows through the apparatus 100, the flow rate fluctuates through the multiple chambers 116 of variable cross-sectional dimension, thereby agitating the beer due to corresponding pressure fluctuation, causing the dissolved nitrogen to “come out” of solution, or otherwise start precipitating, forming an optimal amount of foam (or head) at the top of the vessel 1202 when the vessel 1202 is filled with the beer. At least with nitrogenated beer, the apparatus 100 also produces a cascading effect known as a “reverse waterfall” where bubbles of gas move along the side wall of the vessel 1202 in a downward direction toward the bottom of the vessel 1202.

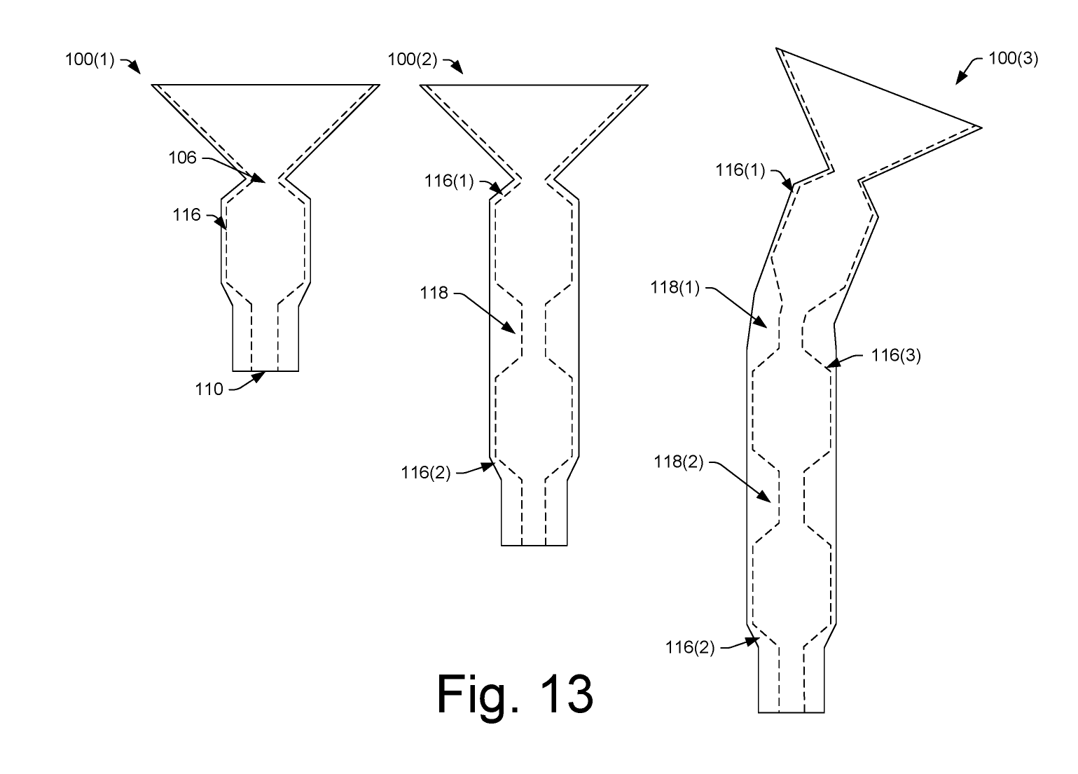

FIG. 13 illustrates side views of various example beverage serving apparatus 100 according to embodiments disclosed herein. A first beverage serving apparatus 100(1) contains a single chamber 116 disposed between the inlet 106 and the outlet 110 of the apparatus 100(1). The example apparatus 100(1) omits a connecting tube 118, but the variable inner cross-sectional dimension of the chamber 116 itself may be sufficient for agitating a liquid having a dissolved gas, such as nitrogenated or carbonated beer, as the liquid flows through the apparatus 100(1). The second beverage serving apparatus 100(2) in FIG. 13 is the same as the beverage serving apparatus 100 shown in FIGS. 1-4, the apparatus 100(2) having two chambers 116 including a proximal chamber 116(1) and a distal chamber 116(2) coupled together by a connecting tube 118 disposed between the proximal chamber 116(1) and the distal chamber 116(2).

The third beverage serving apparatus 100(3) includes three chambers 116 including a proximal chamber 116(1), a distal chamber 116(2), and an intermediate chamber 116(3) disposed between the proximal chamber 116(1) and the distal chamber 116(2). Here, a first connecting tube 118(1) directly couples the proximal chamber 116(1) to the intermediate chamber 116(3), and a second connecting tube 118(2) directly couples the intermediate chamber 116(3) to the distal chamber 116(2). Although the apparatus 100(3) is shown as including three chambers 116, any number of chambers can be included in the beverage serving apparatus 100. For example, more than three chambers 116 can include a proximal chamber 116(1), a distal chamber 116(2), and multiple intermediate chambers 116, such as the intermediate chamber 116(3) shown in FIG. 13.

The apparatus 100(3) is also shown as being angled or curved by virtue of the first connecting tube 118(1) being angled or curved. The angle can be any suitable angle, such as a 45 degree angle, or a bigger or smaller angle. The angled characteristic of the apparatus 100(3) may facilitate a smoother pour of the liquid into the apparatus 100(3) at the inlet structure 112. Furthermore, the angle can be implemented at any point along the conduit 108, including at the inlet structure 112 and/or the outlet structure 114.

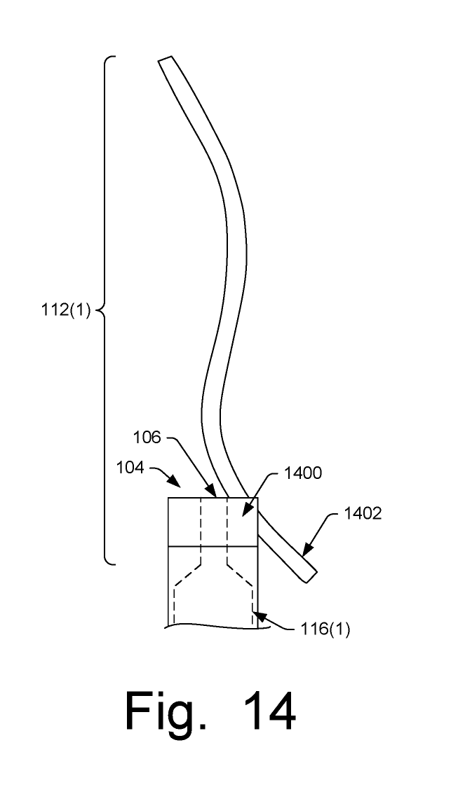

FIG. 14 illustrates a partial side view of an example beverage serving apparatus 100 at a proximal end 104 of the beverage serving apparatus 100. FIG. 14 shows an example inlet structure 112(1) that is different from the funnel inlet structure 112 shown in some of the previous Figures. The inlet structure 112(1) shown in FIG. 14 can include a resilient plug 1400, such as a rubber plug that is configured and dimensioned to be inserted into a mouth of a bottle type container 1200. A tube 1402 may pass through a portion of the resilient plug 1400 and may exit out of a side of the plug 1400 and a top of the plug 1400. In use, the portion of the tube 1402 exiting from the top of the plug 1400 is to be inserted into the bottle type container 1200, and the portion of the tube 1402 exiting from the side of the plug 1400 is to remain outside of the bottle type container 1200. This tube 1402 mitigates the vacuum effect created when a bottle is inverted and liquid is poured from the bottle and into the inlet 106 of the inlet structure 112(1). Thus, instead of situating the apparatus 100 above a vessel 1202 and then pouring liquid from a bottle type container 1200 into the apparatus 100, operation of the apparatus 100 that includes the inlet structure 112(1) shown in FIG. 14 would entail the user inverting the apparatus 100 and inserting the resilient plug 1400 into the opened mouth of an upright bottle type container 1200, and subsequently inverting the apparatus 100 and the bottle type container 1200 to and situating the apparatus 100 and bottle type container 1200 over a vessel 1202 to pour liquid from the bottle type container 1200, through the apparatus 100, and into the vessel 1202.

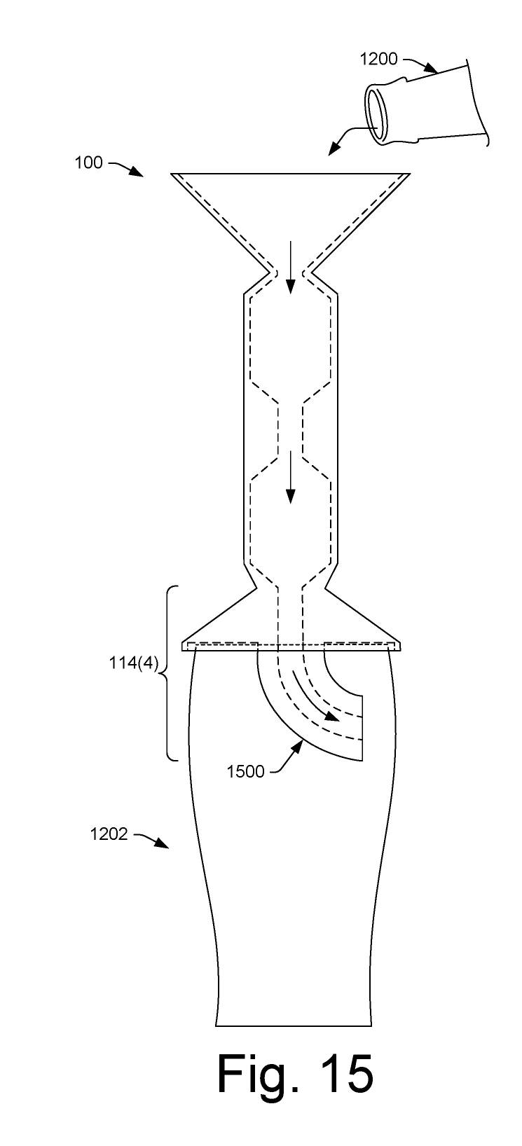

FIG. 15 illustrates a side view of an example beverage serving apparatus 100 that includes an angled or curved outlet structure 114(4). The geometry of the angled or curved outlet structure 114(4) can be varied without departing from the basic characteristics of the angled or curved nature of the outlet structure 114(4). This angled or curved feature of the outlet structure 114(4) mimics the manner in which beer is often delivered from a faucet or a tap seeing as how most bartenders direct beer from a faucet or tap to the side of a glass. Thus, the angled or curved feature of the outlet structure 114(4) allows for the liquid beverage to be directed toward a side of the vessel 1202 as the liquid beverage exits the apparatus 100 through the outlet 110. This may be beneficial for liquid beverages of certain types or having certain amounts of dissolved gas in order to produce the optimal amount of head, provide the optimal amount of head stability, and to produce the optimal amount of dissolved oxygen in the beer after pouring. Alternatively, a substantially straight outlet structure 114, such as the outlet structure 114 shown in FIG. 2, can be oriented at an angle by the user of the apparatus 100 while pouring the liquid beverage into the apparatus 100 to direct the liquid to the side of the vessel 1202 as the liquid exits the apparatus 100. The angled or curved outlet structure 114(4) shown in FIG. 15 can include an angled or curved protrusion 1500 that extends beyond a bottom of the mating feature of the outlet structure 114(4). Any suitable radius of curvature or angle relative to vertical (i.e., a vertical axis running up and down the apparatus 100 when oriented upright) can be utilized with the angled or curved protrusion 1500.

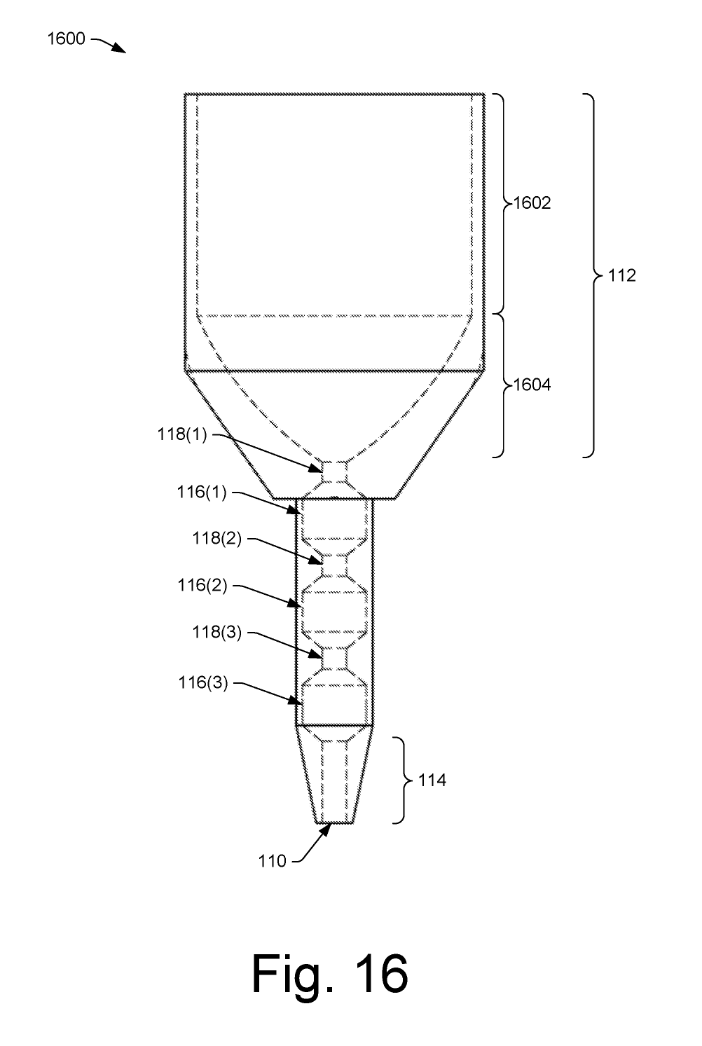

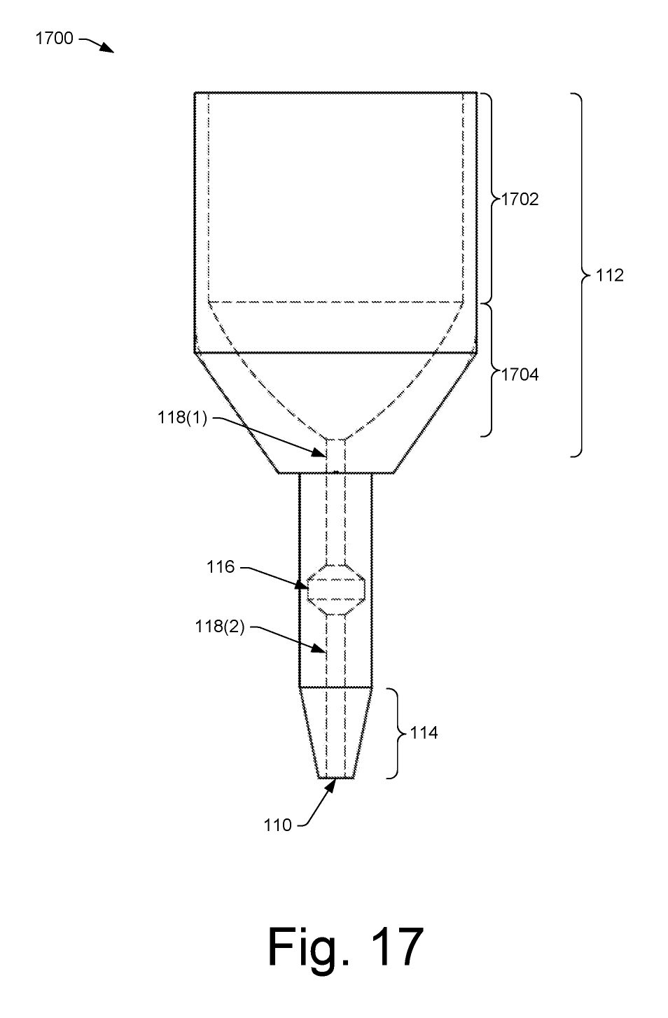

FIG. 16 illustrates a side view of an example beverage serving apparatus 1600 that produces suitable head for nitrogenated beer according to embodiments disclosed herein. The apparatus 1600 is shown as having an inlet structure 112. The inlet structure may have a length that is greater than half the overall length of the apparatus 1600. In some embodiments, the length of the inlet structure 112 is in a range of 80 to 120 mm. The inlet structure 112 is shown as having an overall funnel shape with a generally cylindrical tube portion 1602 at or near the proximal end of the inlet structure 112, and a funnel portion 1604 at or near the distal end of the inlet structure 112. The funnel portion 1604 of the inlet structure 112 may have a curvature to the inner surface, as shown in FIG. 16.

The apparatus 1600 also includes three connecting tubes 118(1)-(3), including a first connecting tube 118(1) that connects the inlet structure 112 to a first chamber 116(1), a second connecting tube 118(1) that connects the first chamber 116(1) and the second chamber 116(2), and a third connecting tube 118(3) that connects the second chamber 116(2) and the third chamber 116(3). An outlet structure 114 may be tapered from a relatively larger diameter to a relatively smaller diameter in a direction from the inlet to the outlet 110 of the apparatus 1600.

In some embodiments, the length, L_{P}, of the proximal portion 700 of any of the individual chambers 116 in FIG. 16 is in a range of 2 to 6 mm. In some embodiments, the length, L_{P}, of the proximal portion 700 may be equal to the length, L_{D}, of the distal portion 704 of any individual chamber 116 in FIG. 16. In some embodiments, the length, L_{M}, of the middle portion 702 of any individual chamber 116 in FIG. 16 is in a range of 8 to 12 mm. In some embodiments, the length, L_{CT}, of any individual connecting tube 118 in FIG. 16 is in a range of 3 to 7 mm.

FIG. 17 illustrates a side view of an example beverage serving apparatus 1700 that produces suitable head for carbonated beer according to embodiments disclosed herein. The apparatus 1700 is shown as having an inlet structure 112. The inlet structure may have a length that is greater than half the overall length of the apparatus 1700. In some embodiments, the length of the inlet structure 112 is in a range of 80 to 120 mm. The inlet structure 112 is shown as having an overall funnel shape with a generally cylindrical tube portion 1702 at or near the proximal end of the inlet structure 112, and a funnel portion 1704 at or near the distal end of the inlet structure 112. The funnel portion 1704 of the inlet structure 112 may have a curvature to the inner surface, as shown in FIG. 17.

The apparatus 1700 also includes two connecting tubes 118(2) and 118(3), including a first connecting tube 118(1) that connects the inlet structure 112 to a single chamber 116, and a second connecting tube 118(2) that connects the single chamber 116 to the outlet 110. An outlet structure 114 may be tapered from a relatively larger diameter to a relatively smaller diameter in a direction from the inlet to the outlet 110 of the apparatus 1700.

In some embodiments, the length, L_{P}, of the proximal portion 700 of the chamber 116 in FIG. 17 is in a range of 2 to 6 mm. In some embodiments, the length, L_{P}, of the proximal portion 700 may be equal to the length, L_{D}, of the distal portion 704 of the chamber 116 in FIG. 17. In some embodiments, the length, L_{M}, of the middle portion 702 of the chamber 116 in FIG. 17 is in a range of 3 to 7 mm.

As used herein, an optimal amount of head on a pint of nitrogenated beer is 2.5 centimeters (cm) to 5 cm. Hard pours often result in a comparable amount of head (e.g., 2.5 cm), but hard pours come with the added drawback of producing as much as 4.6 times the amount of dissolved oxygen in the beer as compared to the dissolved oxygen content in the beer that is poured through the apparatus 100 disclosed herein. Thus, the current disclosure includes methods of utilizing the various beverage serving apparatus disclosed herein to improve dissolved oxygen content in poured beer while achieving an optimal amount of head. Furthermore, foam stability is optimized with the beverage serving apparatus disclosed herein. Foam stability (sometimes referred to herein as “head retention”) can be measured based on the techniques described in Barth, R. The Chemistry of Beer. Wiley. 2013. Chapter 13:231-237 (hereinafter, “Barth”). Barth describes a technique of measuring foam stability by marking the top of the layer of head on the glass immediately after the glass is filled completely with an amount of beer, and subsequently marking the top of the layer of head on the glass after one minute has lapsed since the glass was filled completely with the amount of beer. The vertical distance between the two markings (i.e., the change in head height) can then be taken as a foam stability (or head retention) metric. As used herein, an optimal foam stability metric is 0.5 cm for nitrogenated beer and 0.65 cm for carbonated beer. Hard pours for nitrogenated beer and standard pours for carbonated beer often result in a less stable head, which indicates that hard pours/standard pours create larger bubbles and more rapid dissolution, while pouring beer through the beverage serving apparatus disclosed herein produces uniformly smaller bubbles in both nitrogenated and carbonated beer. Here, “standard pour” means tilting a glass to about 45 degrees, directing beer at the side of the glass as it is poured from a bottle, pouring until the glass is half filled with liquid, and subsequently tilting the glass upright and pouring the remaining beer into the center of the glass. See Bamforth, C. W. The Relative Significance of Physics and Chemistry for Beer Foam Excellence. J. Inst. Brew. 2004. 110(4):259-266. Thus, the beverage serving apparatus disclosed herein more closely replicates a pour produced by a beer/stout faucet without the added drawbacks that come with hard pouring or standard pouring beer.

The current disclosure also provides kits so that pressurized beverages can be enjoyed in numerous settings and contexts. For example, the disclosure includes kits including a beverage serving apparatus disclosed herein in combination with one or more of: a pressurized beverage; a nitrogenated beverage; a nitrogenated beer; a nitrogenated coffee; a beverage glass; a bottle opener; picnic supplies (e.g., a basket, tablecloth, utensils, and napkins), food (e.g., snacks), etc.

### Exemplary Embodiments

1. A beverage serving apparatus including: an inlet structure disposed at a proximal end of the beverage serving apparatus; a proximal chamber coupled to the inlet structure, the proximal chamber having a first inner cross-sectional dimension; a distal chamber coupled to the proximal chamber, the distal chamber having a second inner cross-sectional dimension, wherein the distal chamber has an outlet at a distal end of the beverage serving apparatus, or is coupled to an outlet structure including the outlet at the distal end of the beverage serving apparatus; and a connecting tube disposed between the proximal chamber and the distal chamber and coupling the proximal chamber to the distal chamber, the connecting tube having a third inner cross-sectional dimension that is less than each of the first inner cross-sectional dimension and the second inner cross-sectional dimension.

2. The beverage serving apparatus of embodiment 1, wherein: the first inner cross-sectional dimension is substantially equal to the second inner cross-sectional dimension; and a ratio of the third inner cross-sectional dimension to the first inner cross-sectional dimension or the second inner cross-sectional dimension is a 1:3 ratio.

3. The beverage serving apparatus of embodiment 1, wherein: the first inner cross-sectional dimension is substantially equal to the second inner cross-sectional dimension; and a ratio of the third inner cross-sectional dimension to the first inner cross-sectional dimension or the second inner cross-sectional dimension is within a range of a 1:2.5 ratio to a 1:3.5 ratio.

4. The beverage serving apparatus of any of embodiments 13, alone or in combination, wherein: the proximal chamber, the distal chamber, and the connecting tube are cylindrical in shape; and the first, the second, and the third inner cross-sectional dimensions include first, second, and third inner diameters, respectively.

5. The beverage serving apparatus of any of embodiments 1-4, alone or in combination, wherein the proximal chamber and the distal chamber each include: a proximal portion having a progressively increasing inner cross-sectional dimension in a direction from the inlet to the outlet; a middle portion having a constant inner cross-sectional dimension; and a distal portion having a progressively decreasing inner cross-sectional dimension in the direction.

6. The beverage serving apparatus of any of embodiments 1-5, alone or in combination, wherein: the outlet structure includes a mating feature configured to mate with a portion of a vessel; and the distal chamber is coupled to the outlet structure.

7. The beverage serving apparatus of any of embodiments 1-5, alone or in combination, wherein: the outlet structure comprises an angled or curved protrusion that is configured to direct liquid exiting the outlet toward a vertical wall of a vessel.

8. The beverage serving apparatus of embodiment 6, wherein the mating feature includes an inverted cone that is configured to be inserted into the vessel up to a point where the inverted cone interferes with an angled vertical wall of the vessel at an inner surface of the angled vertical wall.

9. The beverage serving apparatus of embodiment 6, wherein the mating feature includes an inverted cone including: a resting surface that is configured to be placed on a top edge of the vessel; and an annular retainer that is configured to extend around part of an outer surface of the vessel proximate to the top edge of the vessel.

10. A beverage serving apparatus including: an inlet disposed at a proximal end of the beverage serving apparatus; an outlet disposed at a distal end of the beverage serving apparatus; and a conduit extending between the inlet and the outlet, the conduit having a variable cross-sectional dimension along a path from the inlet to the outlet.

11. The beverage serving apparatus of embodiment 10, wherein the conduit is defined by a chamber disposed between the inlet and the outlet, the chamber including: a proximal portion where the variable cross-sectional dimension of the conduit within the proximal portion progressively increases from a first cross-sectional dimension to a second cross-sectional dimension in a direction from the inlet to the outlet, the second cross-sectional dimension being greater than the first cross-sectional dimension; a middle portion where the variable cross-sectional dimension of the conduit within the middle portion remains constant at the second cross-sectional dimension; and a distal portion where the variable cross-sectional dimension of the conduit within the distal portion progressively decreases from the second cross-sectional dimension to the first cross-sectional dimension in the direction.

12. The beverage serving apparatus of embodiment 11, wherein a ratio of the first cross-sectional dimension to the second cross-sectional dimension is a 1:3 ratio.

13. The beverage serving apparatus of embodiment 11, wherein: a ratio of the first cross-sectional dimension to the second cross-sectional dimension is within a range of a 1:2.5 ratio to a 1:3.5 ratio.

14. The beverage serving apparatus of any of embodiments 10-13, alone or in combination, wherein: the conduit is defined by multiple chambers and a connecting tube; the multiple chambers include: a proximal chamber, wherein the conduit within the proximal chamber has a first cross-sectional dimension; and a distal chamber coupled to the proximal chamber, wherein the conduit within the distal chamber has a second cross-sectional dimension; the connecting tube is disposed between the proximal chamber and the distal chamber and couples the proximal chamber to the distal chamber; and the conduit within the connecting tube has a third cross-sectional dimension that is less than each of the first cross-sectional dimension and the second cross-sectional dimension.

15. The beverage serving apparatus of any of embodiments 10-14, alone or in combination, wherein the first cross-sectional dimension is substantially equal to the second cross-sectional dimension; and a ratio of the third cross-sectional dimension to the first cross-sectional dimension or the second cross-sectional dimension is a 1:3 ratio.

16. The beverage serving apparatus of any of embodiments 10-14, alone or in combination, wherein the first cross-sectional dimension is substantially equal to the second cross-sectional dimension; and a ratio of the third cross-sectional dimension to the first cross-sectional dimension or the second cross-sectional dimension is within a range of a 1:2.5 ratio to a 1:3.5 ratio.

17. The beverage serving apparatus of any of embodiments 10-16, alone or in combination, wherein: the proximal chamber, the distal chamber, and the connecting tube are cylindrical in shape; and the first, the second, and the third cross-sectional dimensions include first, second, and third diameters, respectively.

18. The beverage serving apparatus of any of embodiments 10-17, alone or in combination, wherein the multiple chambers further include one or more intermediate chambers disposed between the proximal chamber and the distal chamber.

19. The beverage serving apparatus of embodiment 18, wherein the connecting tube: directly couples the proximal chamber to an intermediate chamber of the one or more intermediate chambers; and is angled or curved.

20. The beverage serving apparatus of any of embodiments 10-19, alone or in combination, further including an inlet structure including the inlet.

21. A beverage serving apparatus including: means for receiving a liquid into the beverage serving apparatus; means for releasing the liquid from the beverage serving apparatus; and means for conveying the liquid from the means for receiving to the means for releasing, the means for conveying having a variable cross-sectional dimension along a path from the means for receiving to the means for releasing.

22. The beverage serving apparatus of embodiment 21, wherein the means for conveying is defined by a means for enclosing the liquid flowing through the beverage serving apparatus, the means for enclosing disposed between the means for receiving and the means for releasing and including: a proximal portion where the variable cross-sectional dimension of the means for conveying within the proximal portion progressively increases from a first cross-sectional dimension to a second cross-sectional dimension in a direction from the means for receiving to the means for releasing, the second cross-sectional dimension being greater than the first cross-sectional dimension; a middle portion where the variable cross-sectional dimension of the means for conveying within the middle portion remains constant at the second cross-sectional dimension; and a distal portion where the variable cross-sectional dimension of the means for conveying within the distal portion progressively decreases from the second cross-sectional dimension to the first cross-sectional dimension in the direction.

23. The beverage serving apparatus of embodiments 21 or 22, alone or in combination, the means for conveying is defined by multiple means for enclosing the liquid and a means for connecting the multiple means for enclosing; the multiple means for enclosing include: a proximal means for enclosing, wherein the means for conveying within the proximal means for enclosing has a first cross-sectional dimension, and a distal means for enclosing coupled to the proximal means for enclosing, wherein the means for conveying within the distal means for enclosing has a second cross-sectional dimension; the means for connecting is disposed between the proximal means for enclosing and the distal means for enclosing and couples the proximal means for enclosing to the distal means for enclosing; and the means for conveying within the means for connecting has a third cross-sectional dimension that is less than each of the first cross-sectional dimension and the second cross-sectional dimension.

24. The beverage serving apparatus of embodiment 23, wherein: the first cross-sectional dimension is substantially equal to the second cross-sectional dimension; and a ratio of the third cross-sectional dimension to the first cross-sectional dimension or the second cross-sectional dimension is a 1:3 ratio.

25. The beverage serving apparatus of embodiment 23, wherein: the first cross-sectional dimension is substantially equal to the second cross-sectional dimension; and a ratio of the third cross-sectional dimension to the first cross-sectional dimension or the second cross-sectional dimension is within a range of a 1:2.5 ratio to a 1:3.5 ratio.

26. A method of promoting precipitation of dissolved gas from a liquid solution containing the dissolved gas, the method including: pouring the liquid solution containing the dissolved gas through a beverage serving apparatus having: an inlet disposed at a proximal end of the beverage serving apparatus; an outlet disposed at a distal end of the beverage serving apparatus; and a conduit extending between the inlet and the outlet, the conduit having a variable cross-sectional dimension along a path from the inlet to the outlet.

27. The method of embodiment 26, wherein the liquid solution is beer or coffee, and the dissolved gas is nitrogen and/or carbon dioxide gas.

28. The method of embodiment 26, further comprising filling a vessel with the liquid solution as the liquid solution is released from the outlet, wherein, upon filling the vessel with a predetermined amount of the liquid solution, a layer of foam is created at a top layer of the liquid solution within the vessel, the layer of foam having a height dimension of at least 2 cm and no greater than 5 cm.

29. The method of embodiment 28, wherein the layer of foam, after one minute of sitting within the vessel, changes in the height dimension by an amount that is no greater than 0.75 cm.

30. The method of embodiment 28, wherein an amount of dissolved oxygen of the liquid solution within the vessel is no greater than 1 ppm.

31. The method of embodiment 26, further comprising, prior to the pouring, placing a filter accessory within an inlet structure at the proximal end of the beverage serving apparatus, and filling the filter accessory with dried hops.

32. A method promoting precipitation of dissolved gas from a liquid solution containing the dissolved gas, the method including: pouring the liquid solution containing the dissolved gas through a beverage serving apparatus having: an inlet structure disposed at a proximal end of the beverage serving apparatus; a proximal chamber coupled to the inlet structure, the proximal chamber having a first inner cross-sectional dimension; a distal chamber coupled to the proximal chamber, the distal chamber having a second inner cross-sectional dimension, wherein the distal chamber has an outlet at a distal end of the beverage serving apparatus, or is coupled to an outlet structure including the outlet at the distal end of the beverage serving apparatus; and a connecting tube disposed between the proximal chamber and the distal chamber and coupling the proximal chamber to the distal chamber, the connecting tube having a third inner cross-sectional dimension that is less than each of the first inner cross-sectional dimension and the second inner cross-sectional dimension.

33. The method of embodiment 32, wherein the liquid solution is beer or coffee, and the dissolved gas is nitrogen and/or carbon dioxide gas.

34. The method of embodiment 32, further comprising filling a vessel with the liquid solution as the liquid solution is released from the outlet, wherein, upon filling the vessel with a predetermined amount of the liquid solution, a layer of foam is created at a top layer of the liquid solution within the vessel, the layer of foam having a height dimension of at least 2 cm and no greater than 5 cm.

35. The method of embodiment 34, wherein the layer of foam, after one minute of sitting within the vessel, changes in the height dimension by an amount that is no greater than 0.75 cm.

36. The method of embodiment 34, wherein an amount of dissolved oxygen of the liquid solution within the vessel is no greater than 1 ppm.

37. The method of embodiment 32, further comprising, prior to the pouring, placing a filter accessory within the inlet structure, and filling the filter accessory with dried hops.

38. A kit including: a pressurized container of liquid, the liquid having a dissolved gas therein; and a beverage serving apparatus having: an inlet disposed at a proximal end of the beverage serving apparatus; an outlet disposed at a distal end of the beverage serving apparatus; and a conduit extending between the inlet and the outlet, the conduit having a variable cross-sectional dimension along a path from the inlet to the outlet.

39. The kit of embodiment 38, wherein the liquid is beer or coffee, and the dissolved gas is nitrogen and/or carbon dioxide gas.

40. The kit of any of embodiments 38 or 39, alone or in combination, further including a bottle opener.

41. The kit of any of embodiments 38-40, further including one or more drinking glasses.

42. A kit including: a pressurized container of liquid, the liquid having a dissolved gas therein; and a beverage serving apparatus having: an inlet structure disposed at a proximal end of the beverage serving apparatus; a proximal chamber coupled to the inlet structure, the proximal chamber having a first inner cross-sectional dimension; a distal chamber coupled to the proximal chamber, the distal chamber having a second inner cross-sectional dimension, wherein the distal chamber has an outlet at a distal end of the beverage serving apparatus, or is coupled to an outlet structure including the outlet at the distal end of the beverage serving apparatus; and a connecting tube disposed between the proximal chamber and the distal chamber and coupling the proximal chamber to the distal chamber, the connecting tube having a third inner cross-sectional dimension that is less than each of the first inner cross-sectional dimension and the second inner cross-sectional dimension.

43. The kit of embodiment 42, wherein the liquid is beer and the dissolved gas is nitrogen and/or carbon dioxide gas.

44. The kit of any of embodiments 42 or 43, alone or in combination, further including a bottle opener.

45. The kit of any of embodiments 42-44, further including one or more drinking glasses.

### EXAMPLES

### Example 1

A first test was conducted by pouring a bottle of Milk Stout made by Left Hand Brewing Company® carefully into a glass in an effort to minimize agitation of the beer and to produce as little head as possible. This was performed in triplicate with beer at the same temperature, and results were measured for each iteration of the test that included: (i) the amount of head at the top of the glass, measured in centimeters along the vertical axis of the upright glass, (ii) the dissolved oxygen content, and (iii) a pH level. The test results were as follows:

| | Head (cm) | pH | dO₂ (ppm) | Temp. (° C.) |
|---|---|---|---|---|
| Rep 1 | Negligible | 4.38 | 0.5 | 10.4 |
| Rep 2 | Negligible | 4.37 | 1.1 | 10.4 |
| Rep 3 | Negligible | 4.37 | 1 | 10.6 |

The measured pH values were temperature-corrected using Equation (1) below:

$$pH ( temp . corrected ) = 7 + ( pH - 7 ) * \frac{T}{T 0} \qquad ( 1 )$$

Here, pH on the right side of Equation (1) represents the measured pH, T represents 298 Kelvin (K) minus the measured temperature, and T₀ represents 298 K. The average temperature-corrected pH was calculated as 4.47, while the average temperature was calculated as 10.47° C., and the average dissolved oxygen (dO₂) was calculated as 0.87 ppm.

### Example 2

A second test was conducted by pouring a bottle of Milk Stout made by Left Hand Brewing Company® using a “hard pour” technique where the bottle of beer is abruptly inverted and poured into the bottom of the glass. This was performed in triplicate with beer at the same temperature, and results were measured for each iteration of the test that included: (i) the amount of head at the top of the glass, measured in centimeters along the vertical axis of the upright glass, (ii) the dissolved oxygen content, and (iii) a PH level. The test results were as follows:

| | Head (cm) | pH | dO₂ (ppm) | Temp. (° C.) |
|---|---|---|---|---|
| Rep 1 | 2 | 4.44 | 4.4 | 10.9 |
| Rep 2 | 2.5 | 4.43 | 4.2 | 10.8 |
| Rep 3 | 2.1 | 4.44 | 3.9 | 10.7 |

The measured pH values were temperature-corrected using Equation (1). The average amount of head was calculated as 2.2 cm (with a standard deviation of 0.26), while the average temperature-corrected pH was calculated as 4.53, the average temperature was calculated as 10.8° C., and the average dissolved oxygen (dO₂) was calculated as 4.17 ppm. The significant increase in dissolved oxygen content using the hard pour method was noticeable from this test.

### Example 3

A third test was conducted by pouring a bottle of Milk Stout made by Left Hand Brewing Company® through a beverage serving apparatus 100 and into a glass. The apparatus 100 used in this test was a three chamber 116 apparatus with an outlet structure 114(3) including a mating feature, much like the beverage serving apparatus 100 shown in FIG. 13, and having an inlet structure 112 much like the inlet structure 112(1) shown in FIG. 14. The length, L, of the apparatus 100 used in the test was 13 cm, while the inner diameter (D1) of the proximal chamber 116(1) of the test apparatus 100 was 15 mm, the inner diameter (D2) of the distal chamber 116(2) was 15 mm, the inner diameter of the intermediate chamber 116(3) was 15 mm, and the inner diameter (D3) of each of the connecting tubes 118(1) and 118(2) was 5 mm. This was performed in triplicate with beer at the same temperature, and results were measured for each iteration of the test that included: (i) the amount of head at the top of the glass, measured in centimeters along the vertical axis of the upright glass, (ii) the dissolved oxygen content, and (iii) a PH level. The test results were as follows:

| | Head (cm) | pH | dO₂ (ppm) | Temp. (° C.) |
|---|---|---|---|---|
| Rep 1 | 1.9 | 4.72 | 1.1 | 12.6 |
| Rep 2 | 1.8 | 4.71 | 1 | 11.9 |
| Rep 3 | 2.5 | 4.68 | 0.6 | 12 |

The measured pH values were temperature-corrected using Equation (1). The average amount of head was calculated as 2.07 cm (with a standard deviation of 0.38), while the average temperature-corrected pH was calculated as 4.8, the average temperature was calculated as 12.17° C., and the average dissolved oxygen (dO₂) was calculated as 0.9 ppm. The significant decrease in dissolved oxygen content using the beverage serving apparatus disclosed herein is noticeable in that the hard pour method produces 4.6 times the dissolved oxygen as pouring beer through the beverage serving apparatus disclosed herein.

Across the three Examples (tests) conducted, the following P-value results were deduced:

| Head (cm) | P-Value |
|---|---|
| T-test, Examples 2 and 3 | 0.64332996 |
| Dissolved O₂ (ppm) | P-Value |
| T-test, Examples 1 and 2 | 0.00015098 |
| T-test, Examples 2 and 3 | 0.00010125 |
| T-test, Examples 1 and 3 | 0.89640831 |
| pH (temperature-corrected) | P-Value |
| T-test, Examples 1 and 2 | 0.00013023 |
| T-test, Examples 2 and 3 | 0.0000330316 |
| T-test, Examples 1 and 3 | 0.0000137964 |

The percent difference in dissolved oxygen between Example 2 (Hard Pour) and Example 3 (pour through the disclosed beverage serving apparatus) was calculated as 363%.

### Example 4

A fourth test was conducted by pouring a bottle of Guinness® Draught (nitrogenated beer having 75% dissolved nitrogen and 25% dissolved CO₂) using a “hard pour” technique where the bottle of beer is abruptly inverted and poured into the bottom of the glass. This was performed in duplicate, and results were measured for each iteration of the test that included: (i) the head height measured in centimeters vertically from the bottom of the layer of head (i.e., the liquid line) to the top of the layer of head, and taken immediately after filling a glass completely with the beer and after the foam had completed formation (i.e., minimal bubble formation in the beer), and (ii) the change in head height, measured by marking a first point on the glass where the top of the layer of head had achieved a maximum height after filling the glass completely with the beer, after one minute has lapsed from marking the first point, marking a second point on the glass corresponding the top of the layer of head, and measuring the vertical distance between the first point and the second point on the glass. The test results were as follows:

| | Head Height (cm) | Δ Head Height (cm) |
|---|---|---|
| Rep 1 | 3.3 | 0.9 |
| Rep 2 | 3.5 | 0.8 |

The average change in head height (foam stability metric) was calculated as 0.85 cm.

### Example 5

A fifth test was conducted by pouring a bottle of Guinness® Draught (nitrogenated beer having 75% dissolved nitrogen and 25% dissolved CO₂) through a beverage serving apparatus 100 and into a glass. The apparatus 100 used in this test was a three chamber 116 apparatus, much like the beverage serving apparatus 100 shown in FIG. 13, and having an inlet structure 112 much like the inlet structure 112(1) shown in FIG. 14. The length, L, of the apparatus 100 used in the test was 13 cm, while the inner diameter (D1) of the proximal chamber 116(1) of the test apparatus 100 was 15 mm, the inner diameter (D2) of the distal chamber 116(2) was 15 mm, the inner diameter of the intermediate chamber 116(3) was 15 mm, and the inner diameter (D3) of each of the connecting tubes 118(1) and 118(2) was 5 mm. This was performed in duplicate, and results were measured for each iteration of the test that included: (i) the head height measured in centimeters vertically from the bottom of the layer of head (i.e., the liquid line) to the top of the layer of head, and taken immediately after filling a glass completely with the beer and after the foam had completed formation (i.e., minimal bubble formation in the beer), and (ii) the change in head height, measured by marking a first point on the glass where the top of the layer of head had achieved a maximum height after filling the glass completely with beer, after one minute has lapsed from marking the first point, marking a second point on the glass corresponding to the top of the layer of head, and measuring the vertical distance between the first point and the second point on the glass. The test results were as follows:

| | Head Height (cm) | Δ Head Height (cm) |
|---|---|---|
| Rep 1 | 4.2 | 0.5 |
| Rep 2 | 4.4 | 0.5 |

The average change in head height (foam stability metric) was calculated as 0.5 cm. This represents a 41% difference between the “hard pour” method of Example 4 and the method of pouring through the beverage serving apparatus 100 of Example 5. Notably, this 41% difference amounts to the beverage serving apparatus 100 providing better foam stability (or head retention) than the hard pour method of Example 4.

### Example 6

A sixth test was conducted by pouring a bottle of Wassail Ale made by Full Sail Brewing® (a carbonated beer) using a “standard pour” technique where the bottle of beer is poured at approximately a 45° angle against the side of the glass. After pouring approximately half of the beer against the side of the glass the glass is turned upright and the remaining beer poured directly into the center of the glass. This was performed in duplicate, and results were measured for each iteration of the test that included: (i) the head height measured in centimeters vertically from the bottom of the layer of head (i.e., the liquid line) to the top of the layer of head, and taken immediately after filling a glass completely with the beer and after the foam had completed formation (i.e., minimal bubble formation in the beer), and (ii) the change in head height, measured by marking a first point on the glass where the top of the layer of head had achieved a maximum height after filling the glass completely with beer, after one minute has lapsed from marking the first point, marking a second point on the glass corresponding to the top of the layer of head, and measuring the vertical distance between the first point and the second point on the glass. The test results were as follows:

| | Head Height (cm) | Δ Head Height (cm) |
|---|---|---|
| Rep 1 | 1.5 | 0.8 |
| Rep 2 | 1.8 | 0.9 |

The average change in head height (foam stability metric) was calculated as 0.85 cm.

### Example 7

A seventh test was conducted by pouring a bottle of Wassail Ale made by Full Sail Brewing® (a carbonated beer) through a beverage serving apparatus 100 and into a glass. The apparatus 100 used in this test was a two chamber 116 apparatus, much like the beverage serving apparatus 100 shown in FIG. 12 herein. The length, L, of the apparatus 100 used in the test was 12 cm, while the inner diameter (D1) of the proximal chamber 116(1) of the test apparatus 100 was 15 mm, the inner diameter (D2) of the distal chamber 116(2) was 15 mm, and the inner diameter (D3) of the connecting tube 118 was 5 mm. This was performed in duplicate, and results were measured for each iteration of the test that included: (i) the head height measured in centimeters vertically from the bottom of the layer of head (i.e., the liquid line) to the top of the layer of head, and taken immediately after filling a glass completely with the beer and after the foam had completed formation (i.e., minimal bubble formation in the beer), and (ii) the change in head height, measured by marking a first point on the glass where the top of the layer of head had achieved a maximum height after filling the glass completely with beer, after one minute has lapsed from marking the first point, marking a second point on the glass corresponding to the top of the layer of head, and measuring the vertical distance between the first point and the second point on the glass. The test results were as follows:

| | Head Height (cm) | Δ Head Height (cm) |
|---|---|---|
| Rep 1 | 4.2 | 0.6 |
| Rep 2 | 4.5 | 0.7 |

The average change in head height (foam stability metric) was calculated as 0.65 cm. This represents a 24% difference between the “-standard pour” method of Example 6 and the method of pouring through the beverage serving apparatus 100 of Example 7 in regards to a carbonated beer; namely Wassail Ale from Full Sail Brewing®. Notably, this 24% difference amounts to the beverage serving apparatus 100 providing better foam stability (or head retention) than the standard pour method of Example 6.

Thus, based on Examples 4, 5, 6, and 7, for both carbonated and nitrogenated beer, head retention was significantly improved using the beverage serving apparatus disclosed herein, as compared to hard pouring or standard pouring the same beer into a glass. This indicates that the beverage serving apparatus disclosed herein produces uniformly smaller bubbles in both carbonated and nitrogenated beer.

The terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment. As used herein, when evaluating an amount of head, a material effect would include an amount of head that is less than 2 cm or greater than 5.5 cm, which would be considered a “design fail”. As used herein, when evaluating foam stability for nitrogenated beer, a material effect would include a foam stability (or head retention) that is greater than 0.6 cm (representing a change in head height after one minute of liquid sitting in a vessel containing the liquid), which would be considered a “design fail.” As used herein, when evaluating foam stability for carbonated beer, a material effect would include a foam stability (or head retention) that is greater than 0.75 cm (representing a change in head height after one minute of liquid sitting in a vessel containing the liquid), which would be considered a “design fail.”

Unless otherwise indicated, all numbers expressing quantities used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3^{rd} Edition or a dictionary known to those of ordinary skill in the art, such as the Oxford Dictionary of Biochemistry and Molecular Biology (Ed. Anthony Smith, Oxford University Press, Oxford, 2004).

What is claimed is:

1. A beverage serving apparatus comprising:
an inlet structure disposed at a proximal end of the beverage serving apparatus;
a proximal chamber coupled to the inlet structure, the proximal chamber having a first inner cross-sectional dimension;
a distal chamber coupled to the proximal chamber, the distal chamber having a second inner cross-sectional dimension, wherein the distal chamber has an outlet at a distal end of the beverage serving apparatus, or is coupled to an outlet structure comprising the outlet at the distal end of the beverage serving apparatus; and
a connecting tube disposed between the proximal chamber and the distal chamber and coupling the proximal chamber to the distal chamber, the connecting tube having a third inner cross-sectional dimension that is less than each of the first inner cross-sectional dimension and the second inner cross-sectional dimension.

2. The beverage serving apparatus of claim 1, wherein:
the first inner cross-sectional dimension is substantially equal to the second inner cross-sectional dimension; and
a ratio of the third inner cross-sectional dimension to the first inner cross-sectional dimension or the second inner cross-sectional dimension comprises a 1:3 ratio.

3. The beverage serving apparatus of claim 1, wherein:
the proximal chamber, the distal chamber, and the connecting tube are cylindrical in shape; and
the first, the second, and the third inner cross-sectional dimensions comprise first, second, and third inner diameters, respectively.

4. The beverage serving apparatus of claim 3, wherein the proximal chamber and the distal chamber each comprise:
a proximal portion having a progressively increasing inner diameter in a direction from the inlet to the outlet;
a middle portion having a constant inner diameter; and
a distal portion having a progressively decreasing inner diameter in the direction.

5. The beverage serving apparatus of claim 1, wherein:
the outlet structure comprises a mating feature configured to mate with a portion of a vessel; and
the distal chamber is coupled to the outlet structure.

6. The beverage serving apparatus of claim 5, wherein the mating feature comprises an inverted cone that is configured to be inserted into the vessel up to a point where the inverted cone interferes with an angled vertical wall of the vessel at an inner surface of the angled vertical wall.

7. The beverage serving apparatus of claim 5, wherein the mating feature comprises an inverted cone comprising:
a resting surface that is configured to be placed on a top edge of the vessel; and
an annular retainer that is configured to extend around part of an outer surface of the vessel proximate to the top edge of the vessel.

8. A beverage serving apparatus comprising:
an inlet disposed at a proximal end of the beverage serving apparatus;
an outlet disposed at a distal end of the beverage serving apparatus; and
a conduit extending between the inlet and the outlet, the conduit having a variable cross-sectional dimension along a path from the inlet to the outlet.

9. The beverage serving apparatus of claim 8, wherein the conduit is defined by a chamber disposed between the inlet and the outlet, the chamber comprising:
a proximal portion where the variable cross-sectional dimension of the conduit within the proximal portion progressively increases from a first cross-sectional dimension to a second cross-sectional dimension in a direction from the inlet to the outlet, the second cross-sectional dimension being greater than the first cross-sectional dimension;
a middle portion where the variable cross-sectional dimension of the conduit within the middle portion remains constant at the second cross-sectional dimension; and
a distal portion where the variable cross-sectional dimension of the conduit within the distal portion progressively decreases from the second cross-sectional dimension to the first cross-sectional dimension in the direction.

10. The beverage serving apparatus of claim 9, wherein a ratio of the first cross-sectional dimension to the second cross-sectional dimension comprises a 1:3 ratio.

11. The beverage serving apparatus of claim 8, wherein:
the conduit is defined by multiple chambers and a connecting tube;
the multiple chambers comprise:
a proximal chamber, wherein the conduit within the proximal chamber has a first cross-sectional dimension, and
a distal chamber coupled to the proximal chamber, wherein the conduit within the distal chamber has a second cross-sectional dimension;
the connecting tube is disposed between the proximal chamber and the distal chamber and couples the proximal chamber to the distal chamber; and
the conduit within the connecting tube has a third cross-sectional dimension that is less than each of the first cross-sectional dimension and the second cross-sectional dimension.

12. The beverage serving apparatus of claim 11, wherein:
the first cross-sectional dimension is substantially equal to the second cross-sectional dimension; and
a ratio of the third cross-sectional dimension to the first cross-sectional dimension or the second cross-sectional dimension comprises a 1:3 ratio.

13. The beverage serving apparatus of claim 11, wherein:
the proximal chamber, the distal chamber, and the connecting tube are cylindrical in shape; and
the first, the second, and the third cross-sectional dimensions comprise first, second, and third diameters, respectively.

14. The beverage serving apparatus of claim 11, wherein the multiple chambers further comprise one or more intermediate chambers disposed between the proximal chamber and the distal chamber.

15. The beverage serving apparatus of claim 14, wherein the connecting tube:
directly couples the proximal chamber to an intermediate chamber of the one or more intermediate chambers; and
is angled or curved.

16. The beverage serving apparatus of claim 8, further comprising an inlet structure comprising the inlet.

17. A beverage serving apparatus comprising:
means for receiving a liquid into the beverage serving apparatus;
means for releasing the liquid from the beverage serving apparatus; and
means for conveying the liquid from the means for receiving to the means for releasing, the means for conveying having a variable cross-sectional dimension along a path from the means for receiving to the means for releasing.

18. The beverage serving apparatus of claim 17, wherein the means for conveying is defined by a means for enclosing the liquid flowing through the beverage serving apparatus, the means for enclosing disposed between the means for receiving and the means for releasing and comprising:
a proximal portion where the variable cross-sectional dimension of the means for conveying within the proximal portion progressively increases from a first cross-sectional dimension to a second cross-sectional dimension in a direction from the means for receiving to the means for releasing, the second cross-sectional dimension being greater than the first cross-sectional dimension;
a middle portion where the variable cross-sectional dimension of the means for conveying within the middle portion remains constant at the second cross-sectional dimension; and
a distal portion where the variable cross-sectional dimension of the means for conveying within the distal portion progressively decreases from the second cross-sectional dimension to the first cross-sectional dimension in the direction.

19. The beverage serving apparatus of claim 17, wherein:
the means for conveying is defined by multiple means for enclosing the liquid and a means for connecting the multiple means for enclosing;
the multiple means for enclosing comprise:
a proximal means for enclosing, wherein the means for conveying within the proximal means for enclosing has a first cross-sectional dimension, and
a distal means for enclosing coupled to the proximal means for enclosing, wherein the means for conveying within the distal means for enclosing has a second cross-sectional dimension;
the means for connecting is disposed between the proximal means for enclosing and the distal means for enclosing and couples the proximal means for enclosing to the distal means for enclosing; and
the means for conveying within the means for connecting has a third cross-sectional dimension that is less than each of the first cross-sectional dimension and the second cross-sectional dimension.

20. The beverage serving apparatus of claim 19, wherein:
the first cross-sectional dimension is substantially equal to the second cross-sectional dimension; and
a ratio of the third cross-sectional dimension to the first cross-sectional dimension or the second cross-sectional dimension comprises a 1:3 ratio.
